(19) United States
(12) Patent Application Publication
(10) Pub. No.: US 2026/0167290 A1
(43) Pub. Date: Jun. 18, 2026

(54) CONTROLLER FOR A LAMP SYSTEM FOR MOTORCYCLES

(71) Applicant: Koito Manufacturing Co., Ltd., Tokyo (JP)

(72) Inventors: Tomoaki HARADA, Shizuoka-shi (JP); Takao MURAMATSU, Shizuoka-shi (JP)

(73) Assignee: Koito Manufacturing Co., Ltd., Tokyo (JP)

(21) Appl. No.: 19/532,218

(22) Filed: Feb. 6, 2026

Related U.S. Application Data
(63) Continuation of application No. PCT/JP2024/028549, filed on Aug. 8, 2024.

(30) Foreign Application Priority Data
Aug. 17, 2023 (JP) 2023-133007

(51) Int. Cl. B62J 6/024; B62J 45/412; G07C 5/02

(52) U.S. Cl. CPC B62J 6/024; B62J 45/412; G07C 5/02

(57) ABSTRACT

A lamp system includes a drive recorder and a headlamp. An ECU predicts a collision of a motorcycle with a preceding vehicle and reduces a brightness of the headlamp based on a prediction result.

### CROSS-REFERENCE TO RELATED APPLICATIONS

This application is a continuation under 35 U.S.C. § 120 of International Application No. PCT/JP2024/028549, filed on Aug. 8, 2024, which claims priority to Japanese Patent Application No. 2023-133007, filed on Aug. 17, 2023. The entire contents of the foregoing applications are incorporated herein by reference in their entirety.

### BACKGROUND

### 1. Technical Field

The present disclosure relates to a lamp system for a motorcycle.

### 2. Description of the Related Art

For the purpose of recording circumstances surrounding the occurrence of traffic accidents or dangerous driving behaviors such as tailgating, an increasing number of automobiles have been equipped with drive recorders. In recent years, drive recorders are also being increasingly installed on motorcycles.

As a result of studying motorcycles equipped with drive recorders, the inventor has come to recognize the following issues.

In a situation where a motorcycle collides with a preceding vehicle, the distance between the motorcycle and the preceding vehicle becomes small, and therefore, the illuminance of the headlamp at the position of the preceding vehicle becomes extremely high. As a result, an image recorded by the drive recorder may cause a license plate of the preceding vehicle to be washed out.

### SUMMARY

The present disclosure has been made in view of the foregoing issues, and one exemplary object of one embodiment of the present disclosure is to provide a lamp system for a motorcycle that is capable of recording important information of a subject even during a collision.

In one aspect of the present disclosure, a control device is provided for a lamp system mounted on a motorcycle that includes a drive recorder. The control device is structured to predict a collision of the motorcycle with a preceding vehicle and to reduce a brightness of a headlamp based on a prediction result.

Note that also free combinations of these constituents, and also any of the constituents and expressions exchanged among the method, apparatus and system, are valid as the aspects of the present invention or the present disclosure. Also note that the description of this section does not describe all essential features of the invention, and thus also subcombinations of these features described may constitute the invention.

### BRIEF DESCRIPTION OF DRAWINGS

Embodiments will now be described, by way of example only, with reference to the accompanying drawings which are meant to be exemplary, not limiting, and wherein like elements are numbered alike in several Figures.

FIG. 1 is a block diagram of a motorcycle equipped with a lamp system according to a first embodiment.

FIG. 2 is a block diagram of a microcontroller serving as an ECU.

FIG. 3 is a flowchart illustrating control performed by the ECU.

FIG. 4 is a view illustrating a motorcycle equipped with the lamp system shown in FIG. 1.

FIG. 5 is a view illustrating an operation of a conventional lamp system.

FIG. 6 is a view illustrating an operation of the lamp system shown in FIG. 1.

FIG. 7 is a block diagram of a motorcycle according to a first modification.

FIG. 8 is a block diagram of a motorcycle equipped with a lamp system according to a second modification.

FIG. 9 is a block diagram of a motorcycle equipped with a lamp system according to a second embodiment.

### DETAILED DESCRIPTION

### Outline of Embodiments

Some exemplary embodiments of the present disclosure will be outlined. This outline is intended for briefing some concepts of one or more embodiments, for the purpose of basic understanding of the embodiments, as an introduction before detailed description that follows, without limiting the scope of the invention or disclosure. Also note this outline is not an extensive overview of all possible embodiments, and is therefore not intended to limit any constituent indispensable for the embodiments. For convenience, the term “one embodiment” may be used to designate one embodiment (Example or Modified Example), or a plurality of embodiments (Examples or Modified Examples) disclosed in the present specification.

A control device according to an embodiment is a control device for a lamp system mounted on a motorcycle having a drive recorder. The control device reduces a brightness of a headlamp based on a prediction result of a collision of the motorcycle with a preceding vehicle.

In this configuration, when a distance between the motorcycle and a preceding vehicle becomes short immediately before a collision, a brightness of the headlamp is reduced. Thus, an illuminance at the preceding vehicle is reduced, and therefore, overexposure in an image recorded by the drive recorder can be prevented, resulting in that important information of a subject can be recorded even during the collision.

In one embodiment, the control device may predict the collision based on a vehicle speed of the motorcycle and an image captured by the drive recorder.

In one embodiment, the control device may predict the collision based on a vehicle speed of the motorcycle and a size of an object appearing in an image. The control device can estimate a distance to the preceding vehicle based on a size of the preceding vehicle appearing in the image captured by the drive recorder. Then, the control device can predict the collision based on a relative relationship between the estimated distance and a stopping distance determined by the vehicle speed.

In one embodiment, the control device may predict the collision based on information from a sensor. The motorcycle may be equipped with an Advanced Rider Assistance System (ARAS) and include sensors such as a millimeter-wave radar, a LiDAR (Light Detection and Ranging) sensor, and a ToF (Time of Flight) camera. In this case, the control device can predict the collision based on at least one of outputs from these sensors.

In one embodiment, the control device may dynamically control a light distribution of the headlamp based on an image captured by the drive recorder. That is, when the headlamp has an Adaptive Driving Beam (ADB) function, a camera for ADB control may be shared with a camera of the drive recorder. This makes it possible to reduce a cost associated with the function.

In one embodiment, a prediction of the collision with the preceding vehicle may be performed by a processing device external to the control device. The control device may receive a prediction result of the collision and control a brightness of the headlamp based on the received prediction result.

In one embodiment, the control device may be housed in a same casing as the headlamp together with the drive recorder. Since the drive recorder needs to be provided at a front portion of the motorcycle, its presence may degrade an aesthetic appearance of the motorcycle. By incorporating the drive recorder into the headlamp, the aesthetic appearance can be improved. Further, when the drive recorder is independent, a lens of the drive recorder may become dirty, resulting in degradation of image quality, and it is difficult for a rider of the motorcycle to notice dirt on the lens of the drive recorder. In a case where the drive recorder is incorporated into the headlamp, although dirt on an outer lens of the headlamp may become an issue, the dirt on the outer lens is far easier to notice and easier to clean than dirt on the lens of the drive recorder.

In one embodiment, the drive recorder and the headlamp may be provided in separate casings, and the control device may be housed in a casing of the drive recorder. When the motorcycle is configured such that the drive recorder can be additionally installed as an option, it is desirable that the drive recorder and the headlamp be provided as separate components.

A lamp system for a motorcycle according to an embodiment may include a drive recorder, a headlamp, and any one of the above-described control devices configured to control the headlamp.

### Embodiments

Preferred embodiments will be explained below, referring to the attached drawings. All similar or equivalent constituents, members and processes illustrated in the individual drawings will be given same reference signs, so as to properly avoid redundant explanations. The embodiments are merely illustrative, and are not restrictive about the disclosure. All features and combinations thereof described in the embodiments are not always essential to the disclosure.

### First Embodiment

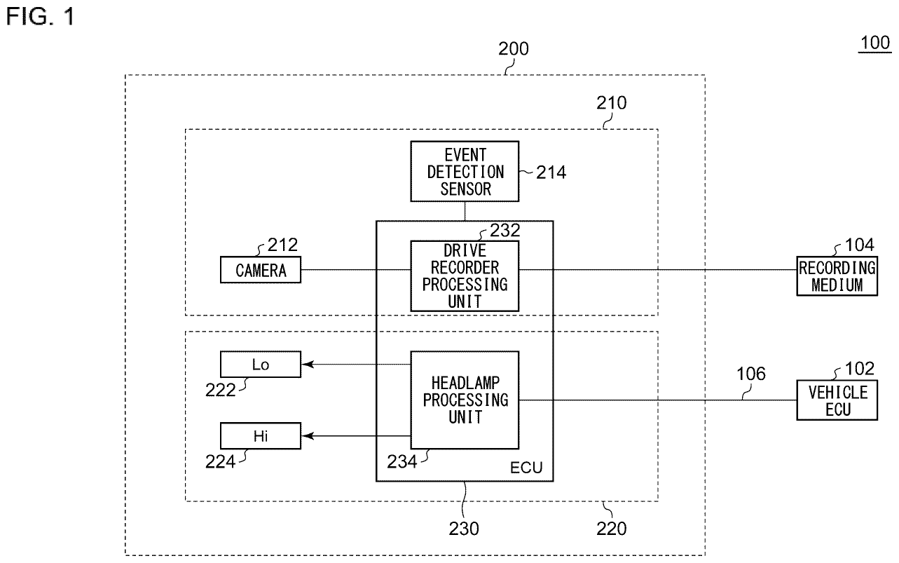

FIG. 1 is a block diagram of a motorcycle 100 equipped with a lamp system 200 according to a first embodiment. The motorcycle 100 includes the lamp system 200, a vehicle ECU (Electronic Control Unit) 102, and a recording medium 104. The vehicle ECU 102 controls the lamp system 200. The lamp system 200 has a function of a headlamp and a function of a drive recorder. The recording medium 104 may be, for example, an SD card, an SSD (Solid State Drive), or a flash memory, and records images generated by the drive recorder. In the block diagram of FIG. 1, the recording medium 104 is provided on a vehicle side, but may alternatively be provided on a side of the lamp system 200.

The lamp system 200 includes a drive recorder 210, a headlamp 220, and an ECU 230. The drive recorder 210 captures an image of a front area of the motorcycle and writes the captured image to the recording medium 104.

The drive recorder 210 includes a camera 212, an event detection sensor 214, and a drive recorder processing unit 232 implemented as a part of the ECU 230. The drive recorder processing unit 232 transfers image data output from the camera 212 to the recording medium 104 and writes the image data thereto. The event detection sensor 214 includes, for example, a gyro sensor and a gravity sensor. The drive recorder processing unit 232, which is a part of the ECU 230, detects a predetermined event, such as a large vibration or a fall of the motorcycle body, in response to an output of the event detection sensor 214. When the drive recorder processing unit 232 detects the event, the drive recorder processing unit 232 switches a recording mode or the like.

The headlamp 220 includes a low-beam unit 222, a high-beam unit 224, and a headlamp processing unit 234 implemented as a part of the ECU 230. The ECU 230 and the vehicle ECU 102 are connected via a vehicle bus 106 such as a CAN bus (Controller Area Network) or a LIN bus(Local Interconnect Network).

The headlamp processing unit 234 turns on the low-beam unit 222 when receiving a low-beam lighting instruction from the vehicle ECU 102, and turns on the high-beam unit 224 when receiving a high-beam lighting instruction from the vehicle ECU 102.

The headlamp processing unit 234 of the ECU 230 predicts a collision of the motorcycle 100 with a preceding vehicle. When a possibility of the collision becomes higher than a predetermined threshold based on a prediction result, the headlamp processing unit 234 reduces a brightness of a lamp (222, 224) that is currently turned on.

The ECU 230 may be a control board configured by combining a microcontroller (MCU) and other hardware, and various processes are performed by a processor executing a software program. Blocks shown inside the ECU 230 in the block diagram schematically and conveniently represent units of processing and functions implemented in the ECU 230.

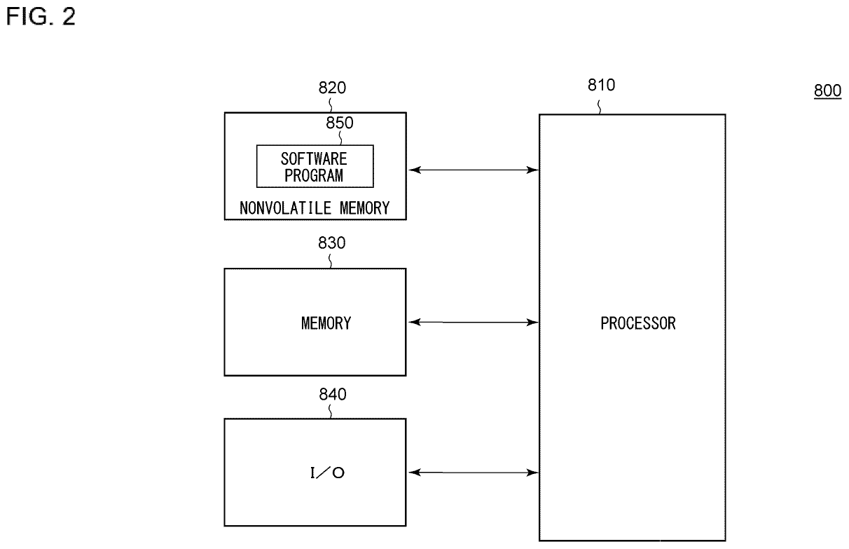

FIG. 2 is a block diagram of a microcontroller 800 included in the ECU 230. The microcontroller 800 includes a processor 810, a nonvolatile memory 820, a memory 830, and an interface circuit 840. The nonvolatile memory 820 is a flash memory and serves as a storage medium that stores the above-described software program 850 executed by the processor 810. At startup, the processor 810 loads the software program 850 into the memory 830 and executes instructions of the software program 850. The interface circuit 840 may include a serial interface such as a UART (Universal Asynchronous Receiver and Transmitter), a three-wire serial interface, or an I2C bus interface, a CAN interface, a GPIO, and an A/D converter or a D/A converter. Components of the microcontroller 800 may be built into a single IC package, or may be configured as a microcontroller board formed by mounting a plurality of IC packages on a printed circuit board.

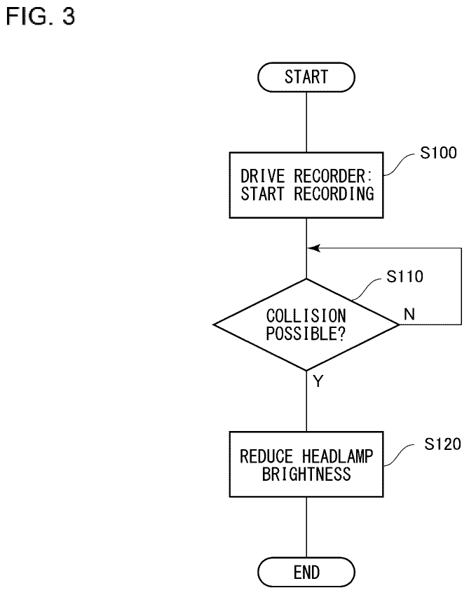

FIG. 3 is a flowchart illustrating control performed by the ECU 230. Capturing by the drive recorder 210 is started (S100). The ECU 230 determines whether there is a possibility of a collision of the motorcycle 100 with a preceding vehicle (S110). When the ECU 230 determines that the possibility of the collision is low (no) (S110: N), the ECU 230 continues to determine the possibility of the collision. When the ECU 230 determines that the possibility of the collision is high (yes) (S110: Y), the ECU 230 reduces a brightness of the headlamp 220 (S120).

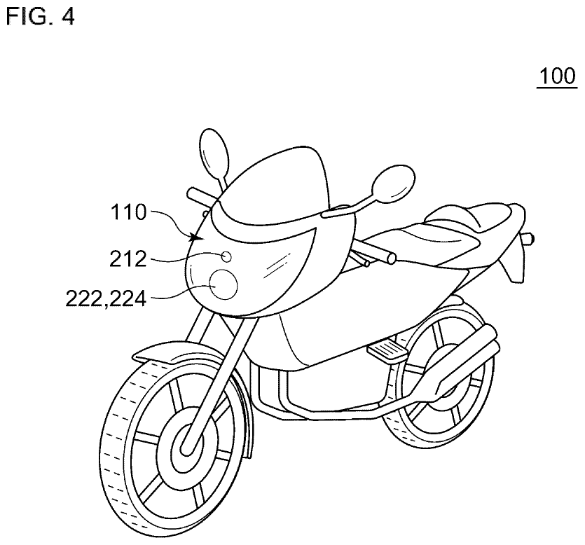

FIG. 4 is a view illustrating the motorcycle 100 equipped with the lamp system 200 shown in FIG. 1. In the present embodiment, the drive recorder 210 and the ECU 230 are housed in a casing 110 of the headlamp. That is, a function of the drive recorder is incorporated into the headlamp. The camera 212 is provided inside the headlamp in the same manner as the low-beam unit 222 and the high-beam unit 224.

The configuration of the lamp system 200 has been described above.

Next, a problem that arises in a headlamp system equipped with a drive recorder will be described.

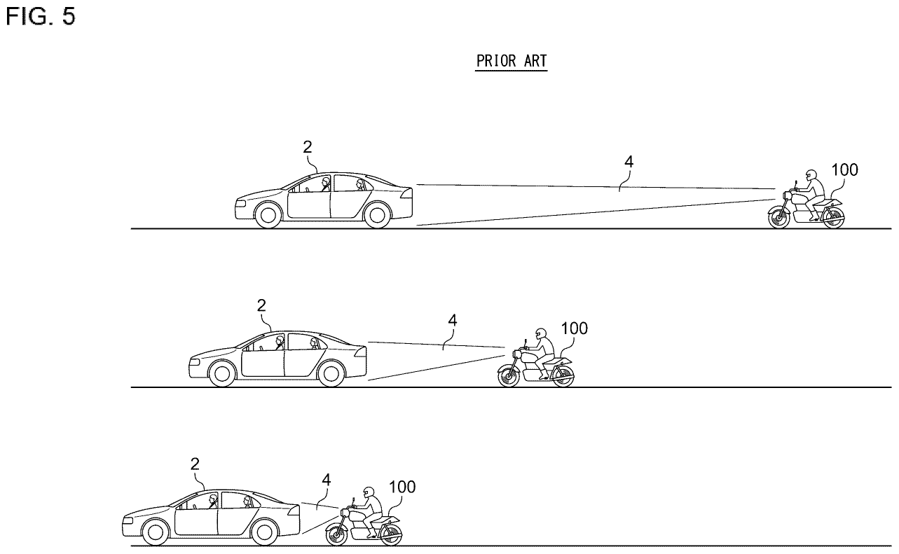

FIG. 5 is a view illustrating an operation of a conventional lamp system. FIG. 5 shows a driving scene immediately before a collision. In the conventional system, a low beam 4 having a constant brightness is irradiated toward a preceding vehicle 2 regardless of a distance to the preceding vehicle 2. In such a case, as the distance to the preceding vehicle 2 becomes short, illuminance on a rear end surface of the preceding vehicle 2 increases, and pixel values of an image of the preceding vehicle 2 captured by the drive recorder, which captures reflected light from the preceding vehicle 2, increase. As a result, the preceding vehicle 2 is overexposed in the image. That is, important information to be recorded by the drive recorder, such as a license plate, may be lost.

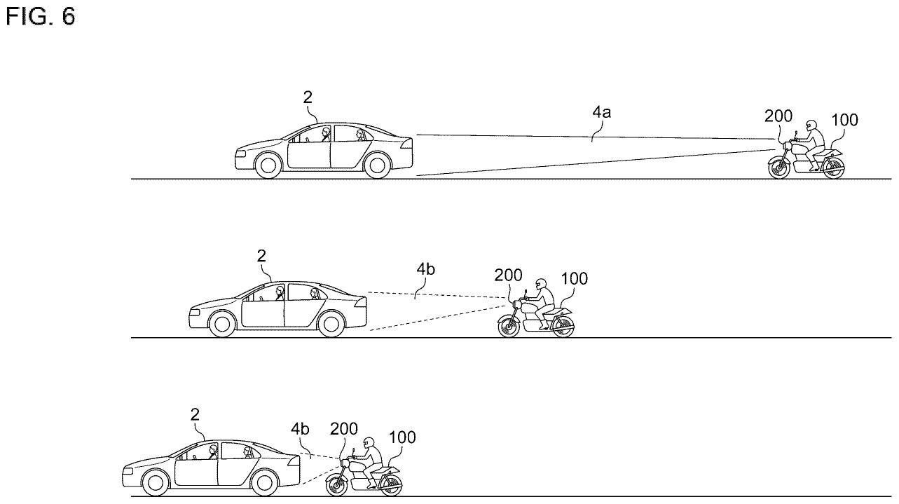

FIG. 6 is a view illustrating an operation of the lamp system shown in FIG. 1. A top portion of FIG. 6 shows a normal driving scene. The low-beam unit 222 emits light with a predetermined brightness, and a low beam 4a that satisfies legal light distribution requirements is irradiated toward a front of the vehicle.

As shown in a middle portion of FIG. 6, when a distance to the preceding vehicle 2 becomes short, the ECU 230 determines that a possibility of a collision with the preceding vehicle 2 has increased. Based on this determination, a light emission brightness of the low-beam unit 222 is reduced, and a low beam 4b becomes darker. Accordingly, at a moment of a collision shown in a lower portion of FIG. 6, illuminance on the preceding vehicle 2 becomes low, and pixel values of an image of the preceding vehicle 2 captured by the drive recorder based on the reflected light become smaller than those in FIG. 5. Thus, overexposure can be suppressed, and loss of important information such as a license plate can be prevented.

Further, in the lamp system 200 of FIG. 1, the drive recorder 210 is incorporated in a casing of the headlamp 220. Since the drive recorder 210 needs to be provided at a front portion of the motorcycle, its presence may degrade an aesthetic appearance of the motorcycle. By housing the drive recorder 210 in the headlamp, the drive recorder 210 can be made less noticeable as shown in FIG. 4, and the aesthetic appearance can be improved.

Further, dirt on a lens of the drive recorder 210 may cause degradation of image quality. When the drive recorder 210 is independent of the headlamp 220, it is difficult for a rider of the motorcycle to notice dirt on the lens of the drive recorder 210. In a case where the drive recorder 210 is housed in the headlamp 220, although dirt on an outer lens of the headlamp 220 may be an issue, the dirt on the outer lens is far easier to notice and easier to clean than dirt on the lens of the drive recorder 210.

Similarly, adhesion of raindrops to a lens of the drive recorder 210 may cause degradation of image quality. When the drive recorder 210 is independent of the headlamp 220, raindrops tend to directly adhere to the lens of the drive recorder 210, and once adhered, the raindrops tend to remain there. In a case where the drive recorder 210 is housed in the headlamp 220, although raindrops adhere to an outer lens of the headlamp 220, the raindrops adhered to the outer lens are likely to flow off due to traveling wind during driving, so that degradation of image quality of the drive recorder can be suppressed.

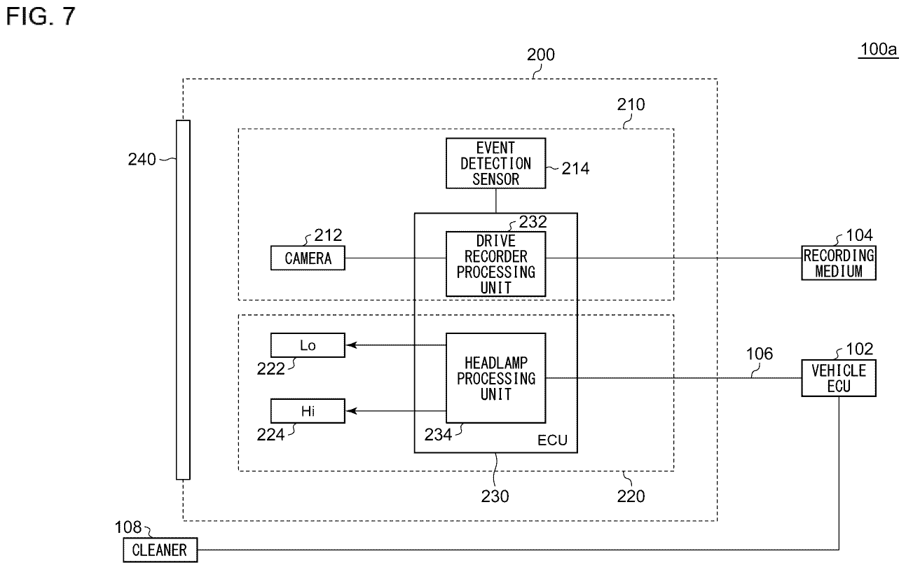

FIG. 7 is a block diagram of a motorcycle 100a according to a first modification. The motorcycle 100a further includes a cleaner 108. The cleaner 108 removes dirt and raindrops adhering to an outer lens 240 of the lamp system 200. According to this modification, the outer lens of the headlamp can be kept clean, and at the same time, degradation of image quality captured by the camera 212 can be suppressed. That is, the cleaner 108 further enhances advantages of housing the drive recorder 210 in a casing of the headlamp.

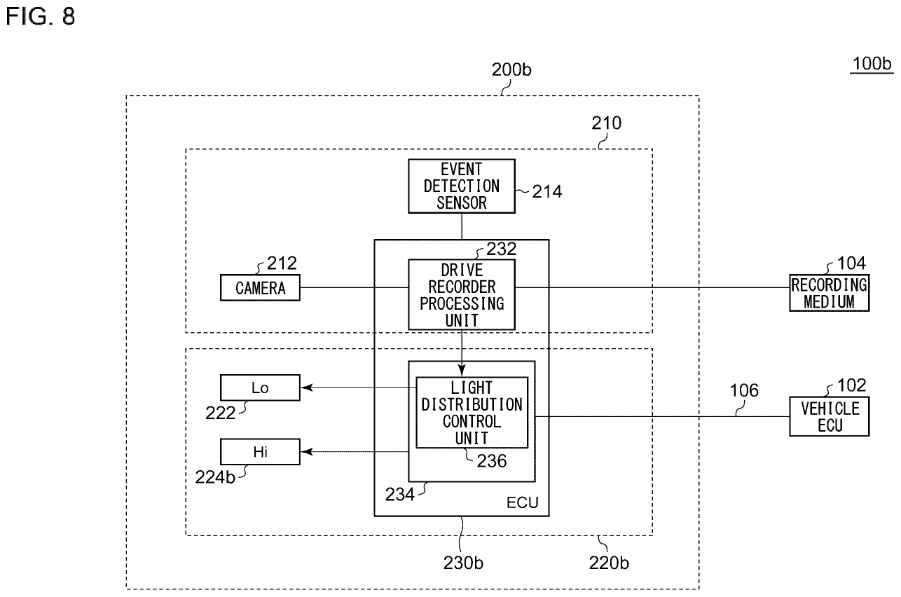

FIG. 8 is a block diagram of a motorcycle 100b equipped with a lamp system 200b according to a second modification. In the lamp system 200b, a headlamp 220b has an ADB (Adaptive Driving Beam) function that adaptively controls a light distribution in accordance with a target object in front of the vehicle. A high-beam unit 224b is a variable light-distribution lamp that can provide a local shading region within a light distribution pattern.

The camera 212 serves both as a camera for the drive recorder and a camera for light distribution control of the ADB. The ECU 230 detects a target object present in front of the vehicle based on an image captured by the camera 212. Then, the ECU 230 generates a light distribution pattern having a shading region at a position where a specific target object exists, and controls the high-beam unit 224b such that this light distribution pattern is obtained. In FIG. 8, this function of the ECU 230 is shown as a light distribution control unit 236.

The second modification can be understood such that a camera for detecting a target object of an ADB lamp also operates as a camera for the drive recorder. Therefore, since it is unnecessary to additionally provide a camera dedicated to the drive recorder, a total cost of the lamp system 200b can be reduced as compared with a configuration in which a camera for the drive recorder and a camera for detecting a target object are separately provided.

### Second Embodiment

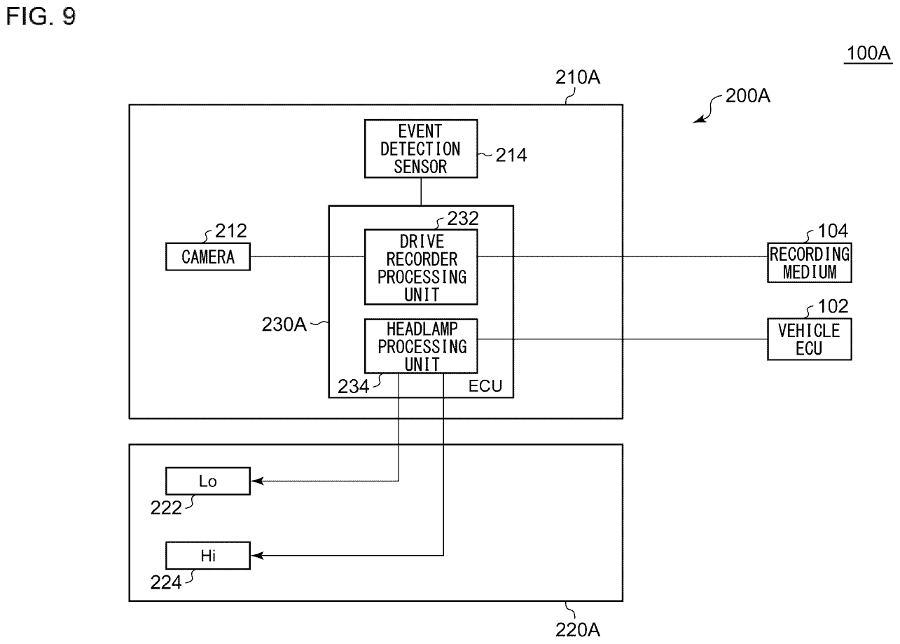

FIG. 9 is a block diagram of a motorcycle 100A equipped with a lamp system 200A according to a second embodiment. The lamp system 200A includes a drive recorder 210A, a headlamp 220A, and an ECU 230A. In the second embodiment, the drive recorder 210A and the headlamp 220A are separately provided as independent units. The ECU 230A is provided on a side of the drive recorder 210A.

Other aspects are the same as those in the first embodiment. The lamp system 200A according to the second embodiment can also suppress overexposure in an image of the drive recorder at the time of a collision, similarly to the lamp system 200 according to the first embodiment.

As a modification of the lamp system 200A shown in FIG. 9, the ECU 230A may be provided on a side of the headlamp 220A.

Next, prediction of a collision performed by the ECU 230 will be described.

The ECU 230 may predict a collision based on a vehicle speed of the motorcycle 100 and an image captured by the camera 212 of the drive recorder 210. The ECU 230 receives vehicle speed information from the vehicle ECU 102 via the vehicle bus 106. The ECU 230 predicts the collision based on a vehicle speed of the motorcycle 100 and a size of an object (preceding vehicle) appearing in the image. The ECU 230 can estimate a distance to the preceding vehicle based on a size of the preceding vehicle in the image, and can predict the collision based on a relative relationship between the estimated distance and a stopping distance determined by the vehicle speed.

Alternatively, in addition to or instead of a size of the object appearing in the image, a distance to the object may be estimated based on a position at which the object appears in the image.

The motorcycle 100 equipped with an Advanced Rider Assistance System (ARAS) may include various sensors such as a millimeter-wave radar, a LiDAR (Light Detection and Ranging) sensor, or a ToF (Time of Flight) camera. In this case, the ECU 230 can predict the collision based on an output of the sensors.

It should be noted that the method of collision prediction is not limited to those described above, and publicly known technologies or technologies that will become available in the future may also be employed.

The embodiments described above are merely illustrative, and it will be understood by those skilled in the art that various modifications to the constituent elements and processing operations thereof may be made. Such modifications are also included within the scope of the present disclosure and the present invention.

What is claimed is:

1. A control device for a lamp system mounted on a motorcycle having a drive recorder, the control device being structured to reduce a brightness of a headlamp based on a prediction result of a collision of the motorcycle with a preceding vehicle.

2. The control device according to claim 1, wherein the control device is structured to predict the collision based on a vehicle speed of the motorcycle and an image captured by the drive recorder.

3. The control device according to claim 2, wherein the control device is structured to predict the collision based on the vehicle speed of the motorcycle and a size of an object appearing in the image.

4. The control device according to claim 1, wherein the control device is structured to predict the collision based on information from a sensor.

5. The control device according to claim 1, wherein the control device is structured to dynamically control a light distribution of the headlamp based on an image captured by the drive recorder.

6. The control device according to claim 1, wherein the control device is housed in a same casing as the headlamp together with the drive recorder.

7. The control device according to claim 1, wherein the drive recorder and the headlamp are provided in separate casings, and the control device is housed in the casing of the drive recorder.

8. A lamp system for a motorcycle, comprising:
a drive recorder;
a headlamp; and
the control device according to claim 1 configured to control the headlamp.

9. A program executed by a control device for a lamp system, the program causing the control device to:
predict a collision of the motorcycle with a preceding vehicle; and
reduce a brightness of a headlamp when there is a possibility of the collision.
